(19) United States
(12) Patent Application Publication
(10) Pub. No.: US 2004/0128343 A1
(43) Pub. Date: Jul. 1, 2004

(54) Method and apparatus for distributing video programs using partial caching

(76) Inventor: Daniel J Mayer, Warren, NJ (US)

Correspondence Address: Gottlieb Rackman & Reisman, 270 Madison Avenue, New York, NY, 10016-0601, US

(21) Appl. No.: 10/311,771

(22) PCT Filed: Jun. 19, 2001
(86) PCT No.: PCT/US01/19558

(51) Int. Cl. G06F 15/16

(52) U.S. Cl. 709/203; 709/231

(57) ABSTRACT

A method and system (10) wherein some segments (A) of at least one program are downloaded from a central location and/or pre-stored in a memory at the premises of the customer. When the customer activates a request, the remaining (complementary) segments of the requested program are streamed over the network from a designated server to the customer's device (25), where they are combined with the first, pre-stored segments, and rendered by the device (25) to provide the consumer with an immediate, high-quality program experience.

### BACKGROUND OF THE INVENTION

A. Field of Invention

This invention pertains to a method and apparatus for preparing and distributing content related programs (such as video or other multimedia programs) from servers to customer (end-user) devices over packet networks (e.g., the Internet). More particularly, the invention pertains to a system wherein some segments of at least one program are downloaded and/or pre-stored in a memory at the premises of the customer. When the customer activates a request, the remaining (complementary) segments of the requested program are streamed over the network from a designated server to the customer's device, where they are combined with the first, pre-stored segments, and rendered by the device to provide the consumer with an immediate, high-quality program experience.

B. Description of the Prior Art

As the technology and deployment of the Internet advances, the use of streaming technology increases. Streamed content is characterized by the ability of the receiving device to render the content (e.g., video programs) to the consumer without waiting for the entire video file to be downloaded. This near-real-time requirement of streaming normally requires the use of specialized connectionless protocols (i.e., UDP/IP) that emphasize speed at the expense of transmission quality and reliability. Typically, streaming protocols do not guarantee that all transmitted packets are received by the consumer's device before rendering commences; another feature of such protocols is that, since packets may travel over diverse routes, the sequence of packets received is not necessarily equal to that transmitted; another feature of such protocols is that some packets may be dropped by equipment at network nodes along the way between the server and the customer's device. Buffering (a temporary form of caching) is typically used to overcome some of the problems presented by streaming protocols. The buffer (memory used for collecting and pre-processing packets) enables the device to collect lagging packets, and to rearrange the sequence of arriving packets before presenting them for rendering to the consumer. This causes the consumer to experience delay before the content requested is rendered, where the delay is proportional to the length of the buffer. The beginning of the program would then be rendered while the remainder of the program continues to stream into the buffer. This scheme works effectively only if, on average, the incoming streaming rate is at least equal to the rate used for rendering the program to the consumer. Frequently this is not the case, and the buffer empties over time, resulting in rendering gaps due to packet drop-outs, which seriously degrade the consumer's experience. This problem is particularly acute in the transmission of video programs, where the consumer attempts to obtain the best program quality rather than the postage-size windows characteristic of video programs encoded for streaming at low bit-rates. The explosion in consumer adoption of broadband Internet access has exacerbated the problem, because the advertised obtainable bit rate is rarely achieved in practice.

Caching is used routinely to accelerate Internet browsing. For example, web pages are stored on a consumer's PC hard drive or in RAM, and retrieved on demand as required; in such application, cached pages are updated only when necessary. Similarly, caching is used in the network to accelerate Internet browsing of cached content; caching “edge” servers (located at the network's edge reasonably close to the end-user) are used to store content that is likely to be requested within a specific geographic area; the content typically mirrors source servers that are centrally located farther away from end-users; these edge caches are updated from the source server when necessary. For example, Inktomi and other equipment vendors provide caching platforms (edge servers) deployed by caching-service providers such as Akamai.

End-users requesting streaming media (normally compressed using some standard or proprietary method; e.g., MPEG-encoded video signals) generally receive better quality service if they receive the content from a local edge server than from a more ‘distant’ Internet location, where ‘the distance’ is determined by connectivity bandwidth and the number of router hops or similar criteria, and not necessarily geographic proximity. Edge-located streaming-media servers cache by maintaining local copies of content that is most likely to be requested by “local” end-users. These types of edge servers generally improve the end-user's available bandwidth and quality of service for streaming media.

Often, neither the caching done at the end-user's premises (for example in the PCs or Internet devices) nor caching at the edge server is sufficient to provide an end-user with high quality streaming media content.

A frequently used technique to overcome these limitations comprises pre-loading entire video programs into the consumer's device (PC or TV Set-Top Box). This technique has several shortcomings. The consumer may not want to delay gratification (until the entire file is downloaded) before experiencing the program. Content owners are apprehensive about the security of content saved on end-user devices, since such local accessibility increases the opportunity for consumers-hackers to break the encryption key associated with each program, and to experience the content without payment and/or license. This problem has been exacerbated by phenomena like Napster, and the fear that decrypted content may be freely shared across the Internet. Content-service providers would like to predictively preload multiple programs on end-user devices, improving the probability that the end-user will actually request to experience a preloaded program. A typical 90-minute movie occupies roughly 500 MB (Megabytes) of hard-drive space when encoded for VHS-quality at 700 Kbs (Kilobits per second); the availability of sufficient hard-drive space for multiple programs limits the service provider's ability to use this technique.

### OBJECTIVES AND SUMMARY OF THE INVENTION

In view thereof, it is an objective of the present invention to provide a system for delivering programs, which can be tailored to provide the consumer with the desired quality of experience in spite of limits on bandwidth or quality of service.

A further objective is to provide a system that significantly increases a consumer's on-demand, high-quality program choices at any particular time.

A further objective is to provide a system and method of distributing media to customers that is flexible so that it can be adjusted easily and automatically for advances in Internet technology, media servers and caches, set-top-boxes, on-premises servers, and PC components.

Yet a further objective is to provide a system and method that provide increased capacity of network-based caching for serving an increased number of programs to customers sharing the same edge server. Other objectives and advantages of the invention will become apparent from the following description.

Briefly, a system for preparing and distributing programs includes a main library used to store a plurality of programs that are available to a set of end-users over the Internet, a process for creating program segments, and a plurality of local libraries, which are preferably implemented by caching edge servers. Each local library is equipped with a subset of the programs also stored by the main library. Programs are assigned to individual local libraries based in the demographics of the end-users being served, the interests expressed by the end-users, etc. As usual for such libraries, programs may be swapped in and out based on administrative “push” (based on predictive demand as projected by the operator of the service), or end-user “pull” (actual end-user demand, or the absence thereof). The system can provide to any of the local-library programs on demand to the end-users. Importantly, the programs are split into at least two segments. The local libraries store entire programs, but preferably store only some of the segments of each program. The remainder segment(s) programs are sent to end-user devices, electronically through a network or on physical media (e.g., CDs, DVDs), for caching.

The program segments cached at end-user sites are selected in either of two ways: (1) using a predictive algorithm to maximize the chances that customers associated with the edge server will want these programs; or (2) in response to customers' explicit request for pre-delivery of segments of specific programs.

When the customer requests a program for viewing, the appropriate program segment from the local edge server is streamed to the customer's site where it is combined with the other segment that has been previously cached at the end-user or customer site. The combined segments are used by a media player to render the program to the customer.

An alternate embodiment is designed to increase the program capacity of servers that are sufficiently well-connected to end-users, so that programs can stream from the edge server to each consumer with high quality. One such case is exemplified by sites associated with a plurality of customers connected to servers via a local network; the server(s) in such networks may cache program segments that can be shared among all customers of the local network.

This invention enables optimized tradeoff between many parameters, including customer-connectivity bandwidth, quality of program-experience, delay of program experience, server resources, and customer's device storage space. While the invention is described in conjunction with the distribution of video programs, it is applicable to audio programs and other programs that are transmitted over packet networks (e.g., the Internet) using streaming techniques.

### BRIEF DESCRIPTION OF THE INVENTION

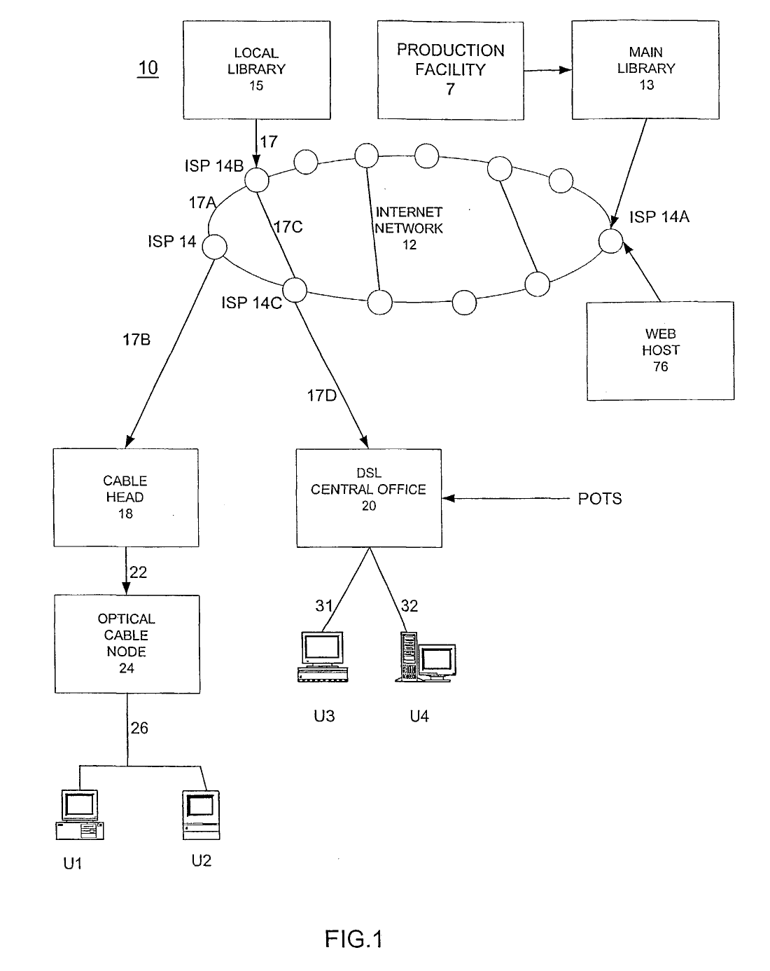

FIG. 1 shows a diagrammatic representation of an Internet system used to distribute programs in accordance with this invention;

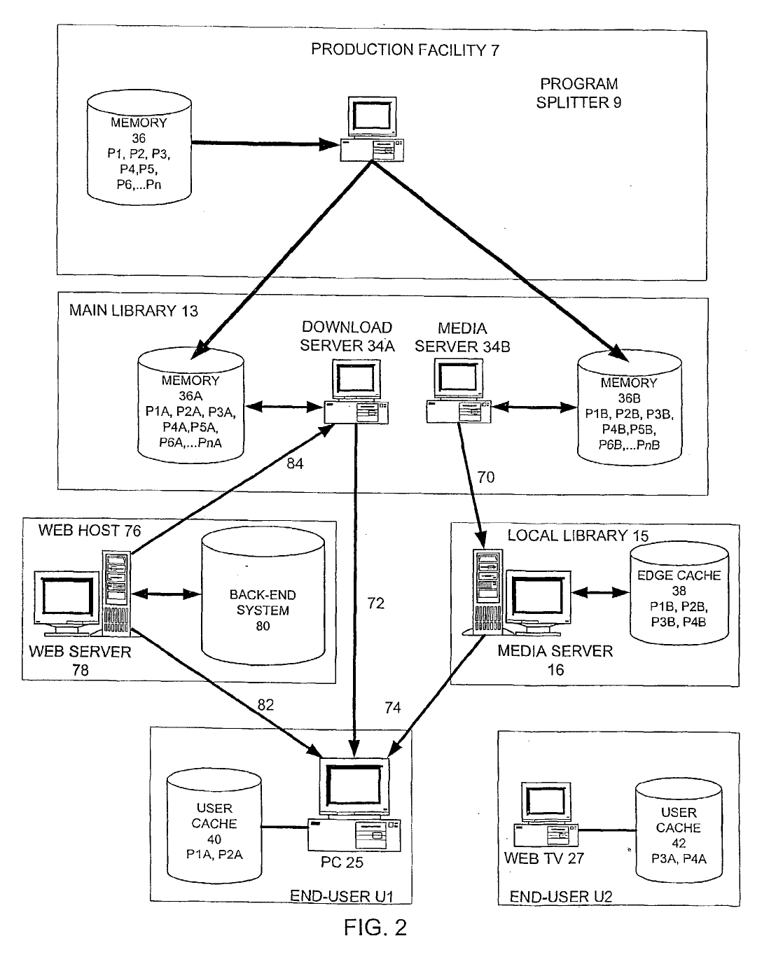

FIG. 2 shows the major components of the system of FIG. 1;

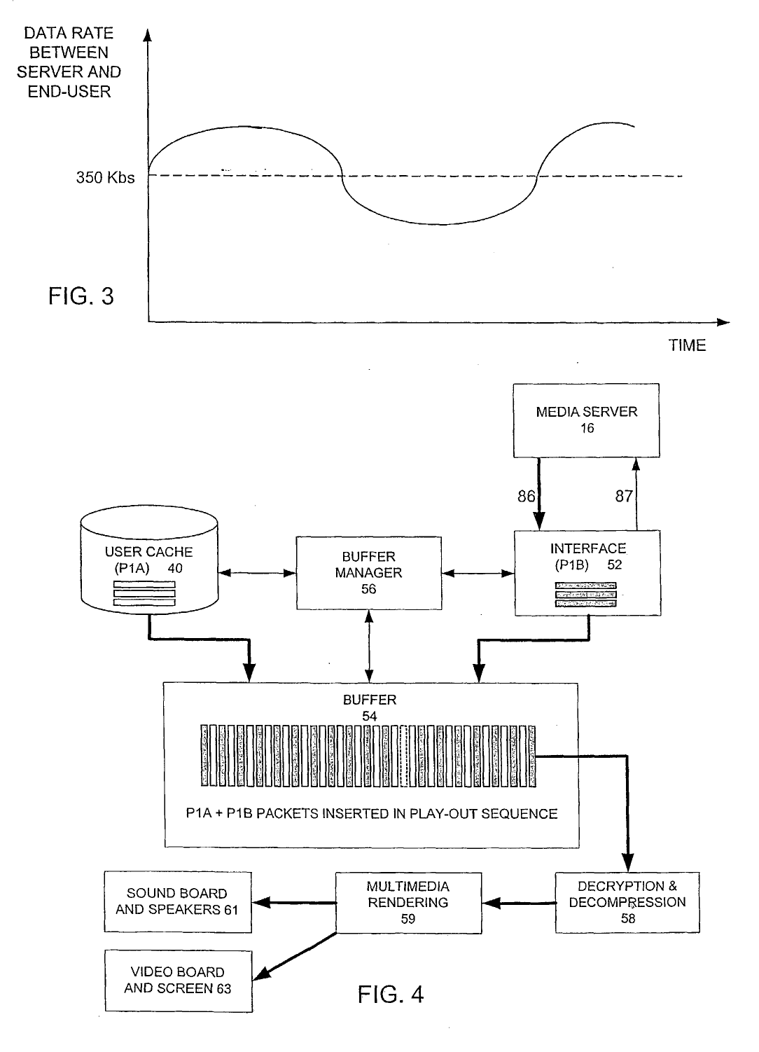

FIG. 3 shows a graph of a typical data transfer rate associated with streaming video signals as a function of time;

FIG. 4 shows a block diagram of a PC used to receive and display programs in accordance with the invention;

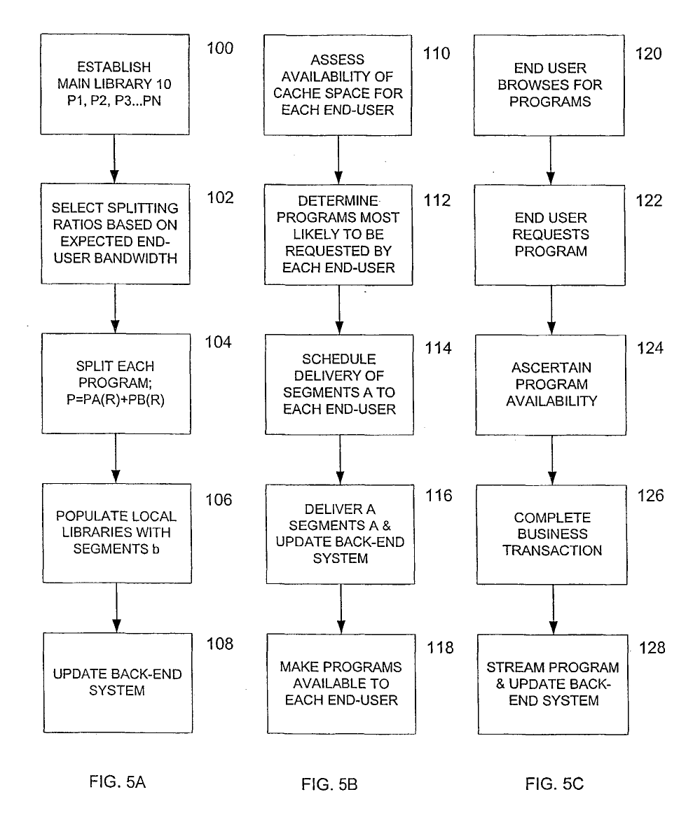

FIG. 5A shows a flow chart illustrating how programs are split and distributed to edge caches;

FIG. 5B shows a flow chart illustrating how end-user caches are pre-populated;

FIG. 5C shows a flow chart illustrating how an end-user receives requested programs;

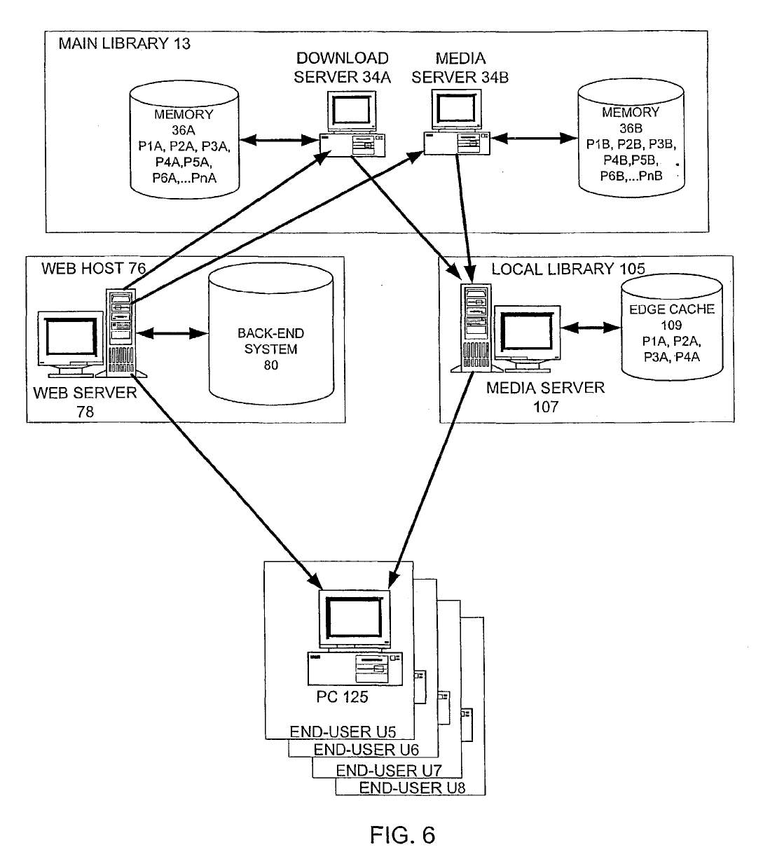

FIG. 6 shows a block diagram of the system for well-connected multiple end-users;

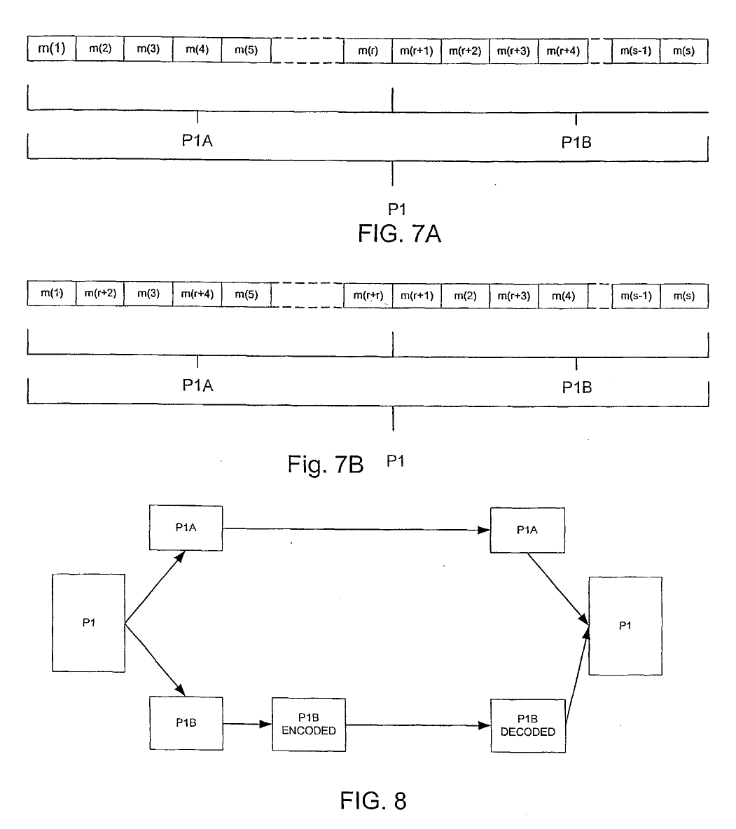

FIG. 7A shows a first method of splitting a program;

FIG. 7B shows a second method of splitting a program; and

FIG. 8 shows diagrammatically the delivery of each program segment to an end-user.

### DETAILED DESCRIPTION OF THE INVENTION

FIG. 3 shows a typical profile of data throughput from the edge server to the end-users (or customers). This figure depicts the average data rate available between a server and an end-user at an average of about 350 Kilobits/second (Kb/s). Assuming that entertainment-quality video requires encoding at a minimum rate of 700 Kb/s (using an efficient data compression scheme, e.g., MPEG-4), then the end-user experiencing connectivity characterized by FIG. 3 will not obtain a satisfactory video-on-demand streaming experience. In order to obtain such experience, the end-user will have to wait for about ½ the duration of the program, until a sufficiently large buffer is filled and the device starts rendering the video. Thus, if a program is an hour long, data must be downloaded for half an hour before it can be played rendered for a satisfactory end-user experience. In order to overcome this problem, in one embodiment of the invention, some segments of the program are downloaded to, or otherwise present in, the device before the end-user decides to watch the same as discussed above.

Referring to FIGS. 1 and 2, a distributed system 10 includes an Internet network 12 having a plurality of components including nodes managed by Internet Service Providers (ISPs) 14 through 14C. The system further includes a production facility 7, a main library 13 and several local libraries, such as local library 15.

Production facility 7 contains a mass memory 36 and a program splitter 9. Memory 36 consists of one or more mass-storage devices. Program splitter 9 consists of one or more processors and associated equipment, and splits each program (i.e., P1, P2, . . . Pn) into at least two complementary program segments A and B. The resulting program segments A of each program P1, P2, P3, . . . . Pn (i.e., P1A, P2A, P3A, . . . PnA) are stored in memory 36A, and the program segments B (i.e., P1B, P2B, P3B, . . . PnB) are stored in memory 36B of main library 13.

In addition to memories 36A and 36B, the main library 13 consists of a download server 34A and media server 34. Download server 34A is provided to downloading program segments A to end-user devices based either on explicit end-user requests, or on conjecture about future end-user requests. Download server 34A downloads these program segments A through a connection provided by ISP 14A to Internet network 12. Alternatively, program segments A can also be distributed to end users over storage media such as CDs and DVDs. Media server 34B is provided to transmit program segments B using streaming over packet networks through the ISP 14A and Internet network 12 to the local libraries. Of course, a main library may be easier to implement as a distributed storage network, however, it is shown here as a single central storage location for the sake of clarity.

Each of the local libraries 15 includes a media server 16 and an edge cache 38. The edge cache 38 may be implemented by one or more mass-storage devices and is used to store program segments B received from the main library 13.

In this manner, initially program segments A are distributed from the memory 36A everywhere, including the caches of end-users U1 through U4 and program segments B are distributed from memory 36B to the local libraries 15. The local libraries 15 store the segments B of programs, and subsequently stream them on demand to its various end-users, such as U1 through U4, as described in more detail below. The selection of what programs to transmit to each of the local libraries 15 is not part of this invention but it may be based on a number of criteria, such as the physical location and demographics of the customers of ISPs 14 and 14C, the popularity of various programs, and so on. All the programs and their segments are preferably stored and transmitted using known compression schemes such as MPEG-4.

Different end users may receive their services by different means. For example, end-users U1 and U2 may obtain their Internet access through cable-TV companies, while U3 and U4 may obtain access through standard telephone lines adapted to provide broadband services through (e.g.,) xDSL technology. In FIG. 1 end-user U1 may own a PC 25 while end-user U2 may own a WebTV (or similar set-top box) 27. In these examples, media server 16 is connected by high-bandwidth connections 17, 17A, and 17B to cable head 18, and through high-bandwidth connections 17, 17C, and 17D to a DSL Central Office 20 equipped with one or more DSLAM frames for providing xDSL services.

Cable head 18 is typically connected by an optical fiber 22 to an optical-cable node 24. Node 24 is then connected to the devices of end-users U1 and U2 over a shared coaxial cable 26. Similarly, the DSL Central Office 20 is connected by twisted copper pairs (standard telephone wire) 31 and 32 directly to connection devices on the premises of end-users U3 and U4. Central Office 20 is also connected to a plain old telephone service or POTS (not shown). The telephone signals from the POTS are superimposed on the Internet signals for telephone signals. Filters used to separate POTS traffic from Internet data have been omitted for the sake of clarity.

As shown in FIG. 2, end-user U1 uses a PC 25 having a user cache 40, while end-user U2 uses a TV Set-Top Box (STB) that is capable of Internet connectivity, such as WebTV 27 having a user cache 42. End-user caches 40, 42 may be incorporated in the respective devices (i.e., PC 25 and WebTV 27), however they are shown here separately for the sake of clarity. Also for the sake of clarity, connections similar to 72, 74, and 82 to end-user U2 have been omitted.

The system may further include a Web host 76, which houses at least one Web server 78 and associated back-end system 80. The back-end system includes processors, software and data designed to administer end-user requests, manage program segments, and assign end-user program requests for fulfillment by an appropriate, such as local library 15. In one embodiment of the invention, any end-user (of U1 through U4) may access content served by web server 78, which provides information on availability and locations of programs in general, and on the identification of segments A that have been pre-loaded at the end-users' sites.

The end-user may trigger a request (e.g., video-on-demand) for a specific program through web-server 78. When web server 78 receives a request for video-on-demand, it consults with back-end 80 to assure that the requesting end-user's site already has the respective segment A. If the end-user site does not have the required segment A, the web server transmits the request to download server 34A, which schedules delivery of the required segment A to the end-viewer's site depending on network conditions and the urgency of the request. Back end 80 keeps track of all requested transactions for future use in billing, royalty payments, and customer service. Specific requests from end-users for segments A are handled by the Web-server 78 in the same manner.

If a whole program is requested, back-end 80 also assigns a local library 15, and conveys this information to the end-user's device. The user's device then accesses media server 16 of the respective local library 15, and the respective program segment B is streamed to the end-user's device. The device (e.g., PC 25) recombines segments A and B and renders the recombined program. Segments A and B are split in such a way that the recombined program is played in or near real time as the streamed segment B arrives. Methods for assigning local libraries to end-users is known in the art, and depends on such criteria as the availability of media server 16, particular content presence at a local library, expected bandwidth availability, and quality of service.

FIG. 4 depicts the operation at the end user's site (in this case, PC 25) required to recombine segments P1A and P1B of a program P1. As discussed above, segment P1A is preloaded or pre-stored in the user cache 40. For clarity, bold arrows in this figure show content flow (e.g., the flow of the video program P1 and its segments P1A and P1B) and regular arrows show the flow of control signals. Buffer manager 56 instructs user cache 40 to pre-populate buffer 54 with the starting portion of program segment P1A. The buffer manager 56 uses frame sequence numbers or rendering-clock values to keep empty buffer slots for P1B packets that are expected to stream-in shortly. Media server 16 starts streaming packets carrying segment P1B to interface 52 of PC 25. This stream is fed to a buffer 54, where buffer manager 56 inserts portions or packets of segment P1B between portions of segment P1A using frame sequence numbers or rendering-clock values so as to reconstruct the initial part of original program P1 within the buffer 54. The rendering clock begins operating as soon as the buffer is sufficiently full with program P1; as depicted in FIG. 4. Therefore it is not necessary for all streamed packets of the segment B to be received before rendering takes place, since video encoding schemes and streaming protocols are robust to some percentage of packet loss. When the rendering clock begins, packets are moved through a decryption/decompression component 58 and then the rendered component 59 (e.g., video board/PC screen 63 and/or soundcard/speakers 61).

Once the stream begins to flow, and the end-user starts to experience the program, buffer manager 56 coordinates the movement of packets in and out of buffer 54. As the buffer fills up, buffer manager 56 sends a feedback message through interface 52 to media server 16 with instructions to pause or slow down the streaming of segment B of the program, so that buffer 54 does not overflow. Thus, as known in the art of adaptive systems, the buffer manager 56 uses feedback messages based on specific thresholds of buffer occupancy using a hysteresis band to optimizes the data transfer rate of segment B. Typically the threshold triggering the request for a pause/slow-down action is higher than the threshold triggering a request to resume/accelerate data transfer. For example, the lower threshold may be about 80% and a higher threshold may be about 90%.

Thus, by splitting program P1, and pre-storing segment P1A of the program into cache 40, the program can be played efficiently by end-user U1 even where the bandwidth/quality-of-service available between the end-user U1 and media server 16 would normally be considered inadequate.

An advantage of this arrangement is that the caches of the end-users can be used to store segments A of several programs. The decision of which programs to store in the caches of the end-users may be made by back-end system 80 based on various demand prediction algorithms, statistical analyses of each end-user, as well as all the end-users, and/or other criteria. Alternatively, the end-users can decide on their own what segments A to pre-store on their own caches. The economic advantage of pre-loading is based on network economics, whereby at-leisure file transfer, which is performed when the network is underused, is far cheaper than real-time streaming performed when the network may be congested.

In another preferred embodiment, program segments A are encoded on physical media such as CDs and DVDs, and distributed to end-users via standard channels such as retail stores, magazine inserts, or through the mail. These physical media could be distributed freely, with payment (if any) for viewing provided (e.g., via credit-card through back-end system 80) before program segments B are delivered.

Preferably, the programs are split so that the program segments A alone are as useless as possible. For this preferred embodiment, program segments A may be embedded in executable programs. When an end-user is connected online, and invokes one such executable program, his site (e.g., PC 25) is connected to back-end system 80 for registration, payment (if desired) is effected, and the matching program segment B is downloaded with the program being played on the fly.

In another preferred embodiment, program segments A are shared by end-users, interconnected by broadband, for example, through peer-to-peer technology. For example, end-user U2 may have received the segment P1A from end-user U1. In this case, back-end system 80 is not aware of the existence of P1A at cache 42 of end-user U2, and may have never encountered this end-user before. As in the prior case, for this embodiment, segment P1A may be embedded within an executable program. When end-user U2 is connected online, and invokes this executable program, WebTV 27 is connected to back-end system 80 for registration, payment (if desired), and streaming of the P1B segment to complete the program P1.

FIG. 6 shows an arrangement in which multiple end-users (represented by U5 through U8) are well connected to the local library 105, which house at least media server 107 and edge cache 109. In this arrangement, the local library 105 is collocated inside a Central Office having SLAM frames serve the end-users based, e.g., on xDSL technology. Alternatively, the local library 105 is coupled to a high speed local area network, and end-users U5 through U8 are connected to the library 105 via the same high speed local area network, with the network having sufficient excess capacity. In this case, the limiting factor is the capacity of edge cache 109 to hold all programs of interest. In a preferred embodiment, edge cache 109 is pre-populated with segments “A” of multiple programs deemed of interest to end users U5 through U8, so that the end-users may share these “A” segments, and not require individual caches within their personal PCs (e.g., PC 125). Thus, if the segments A and B of each program are of equal size, twice as many programs can be populated in edge cache 109 than would otherwise be possible. When end user U5 requests a video (on demand) from Web server 78, back-end system 80 recognizes the environment of that end-user (e.g., from a user profile), and directs PC 125 to request the content from local library 105. Media server 107 then checks to see whether edge cache 107 holds the entire requested content or just the segment A. If the entire requested program is available, media server 106 streams it to PC 125 in the conventional manner. If only segment A of the requested program is available, media server 106 requests the streaming of the matching segment B from media server 34B in main library 13, or from some intermediate, “more local” library with sufficient connectivity bandwidth to local library 105. Media server 107 then combines the two segments (similarly to the manner described above and in FIG. 4), and stream the full content to PC 125 on the fly. Local library 105 may subsequently keep the full recombined program in edge cache 109 if heavy future demand is expected.

One important feature of the invention is the manner in which a program is split into its segments. If the average bandwidth between media server 16 and end-user U1 is about half that required for a high quality video experience, then the program may be split into two equally sized segments, each comprising half of the original program size. Depending on the average data rate bandwidth between media server 16 and the average end-user, the relative sizes of the program segments A and B may be selected to be ¼, ¾ or other ratios as well. A single ratio may be selected for the whole system, or alternatively, each program may be split several times, once for each typical data rate bandwidth between media server 16 and a class of end-users. Then, when preparing to download segment A of programs, a determination can be made of the expected available bandwidth the program P may be split with the ratio is selected that best compensates for these conditions.

When the end-user requests a program video, Web server 78 can control the selection of segment B to be streamed from media server 16, based on split-ratio compatibility with the preloaded segment A.

The operation of the system is best summarized in conjunction with the flow charts of FIGS. 5A, 5B and 5C. Starting in step 100 of FIG. 5A, the main library 13 is established and various programs P1, P1, Pn., are stored in memory 36 of production facility 7 preferably using a compressed, and, optionally, encrypted format. In step 102 the splitting ratios are determined according to the expected classes of end-user bandwidths availability to the end-users. In step 104, program splitter 9 splits each program to at least two segments A, B. Various splitting schemes can be used that are selected based on the following criteria:

(a) make each program segment by itself as useless as possible, so that attempts to experience or hack at any individual segment are economically non-viable;

(b) make each segment compatible with standard media servers without modification;

(c) make each segment (in particular segments B robust to packet losses during transport over the packet network.

Those versed in the art will note that criteria (c) can be met, for example, by splitting streams at the transport layer.

Splitting of programs into their respective segments is shown in more detail in FIGS. 7A, 7B and 8. Referring first to FIG. 7A, a typical program P1 can be represented as a sequence of binary packets m(1), m(2), m(3), . . . m(s). The size of each member m does not matter as long as a preselected criteria, including for example the criteria discussed above, are met. Each packet m may be an integer multiple of the size of data packets, using any of the well-known communication protocol, or some other convenient size. The simplest way to split the program is to take the sequence and divide into two segments P1A, P1B where P1A=m(1), m(2), m(3) . . . m(r); and P1B=m(r+1), m(r+2), m(r+3) . . . m(s). One disadvantage of this system is that it may not be practical because typically information is encoded using several plain text bytes to generate each encoded byte. However, the splitting may occur after encoding, and hence segments m may represent plain text or encoded program segments. Of course, after the program segments are re-assembled, they must be decoded.

In an alternate embodiment of the invention shown in FIG. 7B, instead of just splitting the program P1 into sequential packets, the various packets are interleaved with each other. For example, in FIG. 7B two program segments are defined as follows. First the program P1 is divided in two in a manner similar to FIG. 7A. Then some of the packets are switched between the sides. So, for instance, as shown in FIG. 7B, segment P1A may be formed of packets m(1), m(r+2), m(3), m(r+4) . . . and segment P1b may be defined by packets m(r+1), m(2), m(r+3), m(4), m(r+5) etc.

Of course, the packets can be arranged in many different ways, using simple or complex algorithms to generate the two segments P1A and P1B. For example, stream packets can be split in alternating order (packet 1, 3, 5, . . . ) into segment A, and packets 2, 4, 6, . . . into segment “B”). In yet another embodiment, all key frames (known in the art of video compression) are split into one segment, and all intermediate frames are split into the second segment.

In addition to the above-mentioned criteria, a further consideration for all these schemes is that they have to be reversible so that the packets of the segments can be rearranged in their original order.

As discussed above, one of the criteria for splitting the program is that at least one segment of a program is encrypted to insure that it is not viewed by unauthorized viewers. For example, as shown in FIG. 8, program P1 is first split into two segments P1A and P1B as discussed above. Next, segment P1A is cached. Segment P1B is first encrypted and then stored in cache 38. When the end-user requests program P1, the encrypted segment P1B is sent to the end-user. The encryption key can be sent to the end-user at the same time, or can be provided later, as discussed in more detail below. The end-user then decrypts the segment P1B before combining it with segment P1A.

Again, many other variations may be used in conjunction with encryption. For example, instead of segment P1B, segment P1A may be encrypted, or in the alternative, both segments may be encrypted. In another embodiment of the invention, only a portion of the program P1 may be encrypted. For example, the first ten minutes of the program P1 (or at least one of its segments) may be plain (i.e., not encrypted) to allow an end-user to watch the beginning of a program. If he likes it, he may decide to pay for the rest. After payment is received, the edge server sends the decryption key to the end-user.

Returning to the flow chart of FIG. 5A, in step 106, media server 34B populates all local libraries (e.g., local library 15, and its cache 38) with program segments B appropriate to end-users being served therefrom. In step 108, back-end system 80 is updates with information on the content of all edge caches at all local libraries.

FIG. 5B describes the pre-loading of end-user caches with segments A of programs. In step 110, back-end system 80 assesses the caching space available on each end-user device (e.g., user cache 40) for pre-loading the program segments A. This may be done automatically using, e.g., a client running on PC 25 and reporting through web server 78, or in cooperation with the end-users. In step 112, the programs most likely to be requested by each end user are determined. This can be done individually, by class of user (demographically determined), by past requests associated with the user, based upon explicit user request, or by other means.

Next, in step 114, the back-end system 80 determines the most appropriate time to download segments A to each end-user. This is done using economic and other considerations and prevailing network conditions. In one embodiment segments A are provided by mailing physical media to some end-users. In step 116, back-end system 80 instructs download server 34A to deliver the appropriate A segments A to each end-user who has not received the same on a physical media. Note that download server 34A may be implemented as a plurality of geographically distributed, multiple servers. Once, download completion is confirmed through some protocol (e.g., TCP/IP), the download server informs the back-end system, which updates its end-user records reflecting the change. In step 118, back-end system 80 instructs web server 78 to reflect the availability of the latest programs to the respective end-users and the web server.

FIG. 5C describes the process of serving requested programs to end-users. In step 120, end-user U1 browses web server 78 for available programs, and requests to view one. In step 124 the back end system 80 ascertains the program is available, and that a segment A already resides in user cache 40. The back end system 80 then authorizes web server 78 to proceed with a business transaction (e.g., pay-per-view). In step 126 the business transaction (if any) is completed, and web server 78 provides to end-user PC 25 with the decryption key required to view the program (this key, and the decryption process are optional). In step 128, the back end system 80 authorizes media server 16 to stream the selected segment B to end user U1, and redirects PC 25 to media server 16 for requesting the stream. Segments A and B of the program are recombined in PC 25 as described in FIG. 4, and the end-user experiences (i.e., play) the program. Once the experience is complete, media server 16 updates back end system 80 for accounting and customer care purposes.

A similar process is used for populating servers and serving end users in the arrangement of FIG. 6.

While the invention is described in terms of audio/visual programs, it can be used for other types of programs such as audio programs and the like. Moreover, in the described embodiment, each program is split into two segments. However, programs may be split into more than two segments and each segment may be cached at a different physical location.

Obviously numerous modifications may be made to the invention without departing from its scope as defined in the appended claims.

I claim:

1. A method of distributing audio and/or visual programs comprising the steps of:
splitting a program into a first and a second segment;
storing said first segment for an end-user;
storing said second segment at a server site; and
combining said first and second segment to obtain a combined program at said end-user site.

2. The method of claim 1 further comprising playing said combined programs at an end-user site.

3. The method of claim 1 further comprising encrypting one of said first and second segments.

4. The method of claim 3 further comprising decrypting said one of said first and second segments.

5. The method of claim 1 wherein said first segment is cached at a user site.

6. The method of claim 1 wherein said first segment is cached at a site available for downloading to several users.

7. The method of claim 1 further comprising sending said second segment to said end-user site in response to a program request from the end-user.

8. A method of distributing a plurality programs to a plurality of end-users at end-users caches, some end-user sites including an apparatus for playing said programs, said method comprising:
providing a plurality of programs;
splitting each of said programs into a first and a second segment;
pre-storing the first segments of a group of said programs at a server site;
pre-storing the second segments of said group of said programs in the end-user caches;
sending one of said second segments to one of said end-user sites in response to a program request; and
combining said one second segment and a corresponding first segment to generate a combined program at said end-user site.

9. The method of claim 8 further comprising selecting said group of programs from said plurality of programs for access by said server site.

10. The method of claim 9 wherein said server site is associated with a plurality of end-users, wherein said step of selecting includes performing a predictive analysis of the programs and said plurality of end-users.

11. The method of claim 10 further comprising performing an analysis to determine what program segments are to be stored in which cache site.

12. The method of claim 11 further comprising prestoring the same program segment in several end-user caches.

13. The method of claim 11 further comprising prestoring different program segments in several end-user caches located at respective end-user sites.

14. The method of claim 12 further comprising transmitting program segments from one end-user site to another in response to a program request.

15. The method of claim 8 further comprising encoding said programs before splitting.

16. The method of claim 8 further comprising encrypting one of said program segments.

17. The method of claim 16 further comprising decrypting said program segments prior to combining the segments.

18. The method of claim 7 wherein said step of splitting includes dividing each said program into a sequence of segments and assigning each segment of said sequence to one of said segments.

19. The method of claim 18 further comprising interleaving said segments.

20. A distribution system for distributing a plurality of programs to a plurality of end-users, comprising:
a splitting device that splits said programs into corresponding first and second segments;
a plurality of end-user caches holding a set of said first segments;
a plurality of end-user sites; and
a server site including a server cache holding a set of said second segments;
wherein in response to a request for a program for a predetermined end-user, said server sends the corresponding second segment from said set of second segments to the corresponding cache; and
wherein at the corresponding end-user site, the first and the second segments are combined to form a combined program.

21. The system of claim 20 wherein said end-user site includes a player that plays said combined program.

22. The system of claim 20 further comprising an analyzer adapted to perform an analysis of programs associated with said cache and end-users associated with said server site, said analyzer using said analysis to define said set of said first program segments.

23. The system of claim 20 further comprising a main library number of programs, programs associated with said server and said end-user sites.

24. The system of claim 23 further comprising an analyzer that analyzes the programs and determines the programs associated with said server site.

25. The system of claim 20 further comprising a first and a second end-user cache, each end-user cache being disposed at a corresponding end-user site and storing the same set of second segments.

26. The system of claim 20 further comprising a first and a second end-user cache, each end-user cache being disposed at a corresponding end-user site and storing a different set of second segments.

27. The system of claim 26 wherein said first and second caches are adapted to share second segments between said end-user sites.

28. The system of claim 20 further comprising a program control device disposed at some of said end-user sites, said program control devices being adapted to receive requests from end-users for programs.

29. The system of claim 28 wherein each program control device includes a first buffer arranged to receive said first segment from said end-user cache, a second buffer arranged to receive said second segment from said server cache and an accumulator adapted to combine said first and second segments into said combined program.
